(19) United States
(12) Patent Application Publication
(10) Pub. No.: US 2012/0128089 A1
(43) Pub. Date: May 24, 2012

(54) WIRELESS COMMUNICATION SYSTEM, TRANSMITTING APPARATUS, WIRELESS COMMUNICATION METHOD, AND CONTROL METHOD FOR TRANSMITTING APPARATUS

(75) Inventor: Masafumi TSUTSUI, Kawasaki (JP)

(73) Assignee: FUJITSU LIMITED, Kawasaki-shi (JP)

(21) Appl. No.: 13/298,555

(22) Filed: Nov. 17, 2011

(30) Foreign Application Priority Data
Nov. 19, 2010 (JP) 2010-258582

(51) Int. Cl. H04B 7/02

(52) U.S. Cl. 375/267

(57) ABSTRACT

A wireless communication system includes a transmitting apparatus, and a plurality of receiving apparatuses. A first receiving apparatus among the plurality of receiving apparatuses includes, a first receiver that receives wireless signals transmitted from a plurality of antennas of the transmitting apparatus, a first processor that selects, from among a plurality of transmission weights, a transmission weight that allows a quality of a wireless signal to satisfy specified criteria, and a first transmitter that transmits weight information concerning the selected transmission weight to the transmitting apparatus. The transmitting apparatus including a second receiver that receives the weight information from the first receiving apparatus, and a second processor that corrects for a phase difference among the plurality of antennas based on the weight information, the weight information relating to positional information concerning a position of the first receiving apparatus.

### CROSS-REFERENCE TO RELATED APPLICATIONS

This application is based upon and claims the benefit of priority from the prior Japanese Patent Application No. 2010-258582 filed on Nov. 19, 2010, the entire contents of which are incorporated herein by reference.

### FIELD

Embodiments of the present invention relate to a wireless communication system, a transmitting apparatus, a wireless communication method, and a control method for the transmitting apparatus.

### BACKGROUND

These days, research is being actively conducted on Multiple Input Multiple Output (MIMO)-system wireless communication methods. In a MIMO wireless communication system, a transmitting apparatus including a plurality of transmission antennas transmits a plurality of data streams, and a receiving apparatus receives the plurality of data streams transmitted from the transmitting apparatus by using a plurality of reception antennas to recover data from the received plurality of data streams.

Additionally, a Multiple Input Single Output (MISO) method is also known. In the MISO method, a transmitting apparatus transmits a plurality of data streams by using a plurality of transmission antennas, and a receiving apparatus receives the plurality of data streams by using a single reception antenna so as to recover data from the plurality of data streams.

Further, beamforming is a known method for forming a beam in a desired direction by multiplying a plurality of antennas or data streams by a combination of weight coefficients (also called “a weight set”).

The beamforming technique enables a transmitting apparatus, when transmitting wireless signals, to improve directivity gain characteristics due to the constructive interference of beams and also to suppress the occurrence of interferences due to the destructive interference of beams. When receiving wireless signals, the transmitting apparatus is able to form beams in the directions of arrival of wireless signals, thereby improving the reception characteristics.

The following beamforming techniques are known.

In one method, a base station places and adjusts the power of a data signal and the power of a reference signal for a resource block to which beamforming is applied. In this case, when adjusting the power of the data signal and the power of the reference signal, the power of unused subcarriers is used as the power of the reference signal. Such a method is disclosed in, for example, Japanese Laid-Open Patent Publication No. 2010-41473.

In another method, upon reception of feedback information for correcting a variation in the phase among a plurality of transmission circuits having different systems, a base station reads beamforming information to correct for the variation from a codebook. Such a method is disclosed in, for example, Japanese Laid-Open Patent Publication No. 2008-53933.

There is also another method for performing double processing on a target signal by using a combination of coding based on spatial characteristics and precoding based on a codebook. Such a method is disclosed in, for example, Japanese Laid-Open Patent Publication No. 2010-158021.

In yet another known method. A wireless base station stores a beam number that was previously transmitted. Upon receiving from a user terminal a feedback signal indicating a difference value between the previously transmitted beam number and a subsequent beam number the user terminal prefers, the wireless base station combines the previously transmitted beam number and the difference value, thereby reproducing the beam number that the user terminal prefers. Then, precoding processing adaptable for the reproduced beam number is performed. Such a method is disclosed in, for example, International Publication Pamphlet No. 2008-126378.

### SUMMARY

According to an aspect of the invention, a wireless communication system includes a transmitting apparatus, and a plurality of receiving apparatuses. A first receiving apparatus among the plurality of receiving apparatuses includes, a first receiver that receives wireless signals transmitted from a plurality of antennas of the transmitting apparatus, a first processor that selects, from among a plurality of transmission weights, a transmission weight that allows a quality of a wireless signal to satisfy specified criteria, and a first transmitter that transmits weight information concerning the selected transmission weight to the transmitting apparatus. The transmitting apparatus including a second receiver that receives the weight information from the first receiving apparatus, and a second processor that corrects for a phase difference among the plurality of antennas based on the weight information, the weight information relating to positional information concerning a position of the first receiving apparatus.

According to an aspect of wireless communication system includes a second processor that corrects for a phase difference among the plurality of antennas based on the weight information, the weight information relating to positional information concerning a position of the first receiving apparatus

The object and advantages of the invention will be realized and attained by at least the features, elements, and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates examples of beamforming methods.

FIG. 2 illustrates an example of the configuration of a wireless communication system according to an embodiment.

FIG. 3 illustrates an example of the configuration of a wireless terminal illustrated in FIG. 2.

FIG. 4 illustrates an example of the configuration of another wireless terminal illustrated in FIG. 2.

FIG. 5 illustrates an example of the configuration of a wireless base station illustrated in FIG. 2.

FIG. 6 illustrates an example of the configuration of a correction section illustrated in FIG. 5.

FIG. 7 is a flowchart illustrating an example of the operation performed by a wireless communication system according to an embodiment.

FIG. 8 illustrates an example of the configuration of a wireless communication system according to a first modified example.

FIG. 9 illustrates an example of the configuration of a wireless communication system according to a second modified example.

FIG. 10 illustrates an example of the configuration of a wireless communication system according to a third modified example.

### DESCRIPTION OF EMBODIMENTS

Beamforming techniques are broadly divided into the following two types of method.

One type of method is a method called precoding. In this precoding method, a transmitting apparatus and a receiving apparatus each have the same codebook in which usable weight sets are stored. The transmitting apparatus first transmits wireless signals by using a plurality of antennas, and the receiving apparatus selects a transmission weight that allows the quality of a wireless signal received from the transmitting apparatus to satisfy predetermined and/or specified criteria, for example, maximizing the reception gain. Then, the receiving apparatus transmits an index corresponding to the selected transmission weight, and the transmitting apparatus forms a transmission beam by using the transmission weight corresponding to the index notified by the receiving apparatus. Thereafter, the transmitting apparatus transmits wireless signals by using the formed transmission beam. The weight set may also be referred to as a precoding matrix (vector group formed of a plurality of vectors), and the index may be referred to as a precoding matrix indicator (PMI).

The other type of method is a method in which the above-described codebook is not used. In this method, a transmitting apparatus first estimates the direction of arrival of a wireless signal received from a receiving apparatus or a channel matrix between the transmitting apparatus and the receiving apparatus, and determines a transmission weight used for forming a transmission beam based on the estimation result. The transmitting apparatus then forms a transmission beam by using the determined transmission weight. Thereafter, the transmitting apparatus transmits wireless signals by using the formed transmission beam. If this method is used, it is preferable that the transmitting apparatus be provided with a calibrator (e.g., calibration circuit) for correcting for a variation, such as the phase difference or the amplitude difference, among branches, such as those of wireless circuits and antennas, in order to precisely estimate the directions of arrival of signals or a channel matrix.

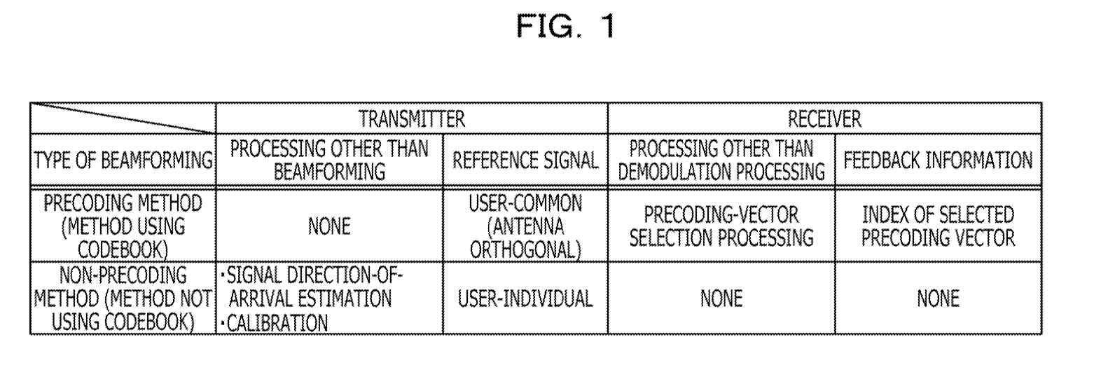

FIG. 1 illustrates example characteristics of the above-described beamforming methods.

As illustrated in FIG. 1, when the precoding method is employed, the transmitting apparatus performs beam forming processing without performing calibration. As the reference signal contained in a wireless signal, a pilot signal used for all users (hereinafter also referred to as a “user-common pilot signal”) is utilized. The user-common pilot signal has orthogonality among antennas of the transmitting apparatus.

In the precoding method, in addition to demodulation processing, the receiving apparatus selects a precoding vector and feeds back the index corresponding to the selected precoding vector to the transmitting apparatus.

In the non-precoding method (codebook is not used), in addition to beamforming, the transmitting apparatus estimates the direction of arrival of a signal received from the receiving apparatus, and also performs calibration. As the reference signal contained in a wireless signal, a pilot signal which is user specific (hereinafter also referred to as the “user-individual pilot signal”) is utilized. It is not necessary that the user-individual pilot signal have orthogonality among antennas of the transmitting apparatus.

In the non-precoding method, the receiving apparatus performs demodulation processing, but there is no information which is to be fed back to the transmitting apparatus.

Comparing the two methods, in the precoding method, the transmitting apparatus and the receiving apparatus both contribute to the execution of the processing operations and are operated in cooperation with each other. In contrast, in the non-precoding method, the transmitting apparatus performs almost all the processing operations, and the receiving apparatus performs reception (demodulation) processing.

As described above, in the non-precoding method, it is preferable that a calibrator be used. In most of the cases, a calibrator used for calibration processing is configured as hardware, which increases the manufacturing cost of the transmitting apparatus.

In contrast, in the precoding method, the receiving apparatus selects, from among a plurality of transmission weights (weight sets) stored in the codebook, a transmission weight that allows the quality of a wireless signal received from the transmitting apparatus to satisfy specified and/or predetermined criteria, and then feeds back the index corresponding to the selected transmission weight to the transmitting apparatus. In the known precoding method, therefore, beamforming is performed based on a codebook that stores finite weight sets, and thus, an improvement in, for example, the reception characteristics, by using beamforming may be restricted.

An embodiment of the present invention will be described below with reference to the accompanying drawings.

### [1] Embodiment

### (1.1) Example Configuration of Wireless Communication System

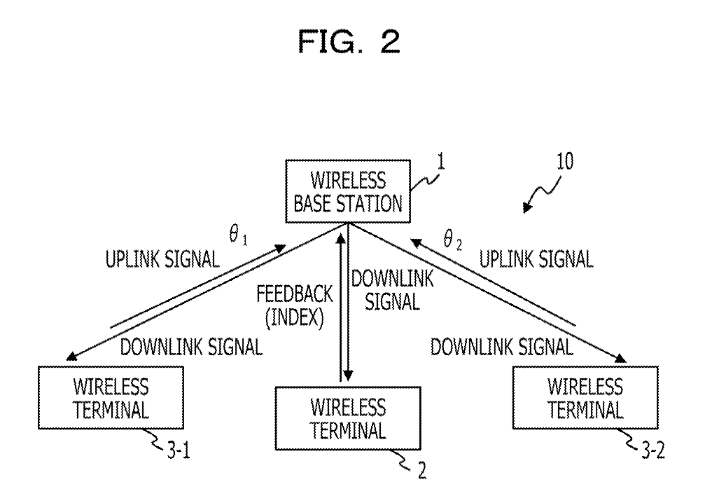

FIG. 2 illustrates an example of the configuration of a wireless communication system 10 according to an embodiment.

The wireless communication system 10 includes, as illustrated in FIG. 2 by way of example, a wireless base station 1, a wireless terminal 2, which is one example of user equipment (UE), and wireless terminals 3-1 and 3-2. Hereinafter, if the wireless terminals 3-1 and 3-2 are not distinguished from each other, the terminals are referred to as the “wireless terminal 3”. The numbers of wireless base station 1, wireless terminal 2, and wireless terminal 3 included in the communication system 10 are not restricted to those illustrated in FIG. 2. Further, at least the wireless terminal 3 may be moved by a user, and in that sense, the wireless terminal 3 is used synonymously with a wireless mobile terminal or a mobile station (MS).

The wireless base station 1 serves the function of a transmitting apparatus that includes a plurality of antennas and transmits wireless signals by utilizing transmission beamforming.

For example, the wireless base station 1 provides a wireless area formed of cells or sectors, and is able to perform wireless communication with the wireless terminals 2 and 3 located in the wireless area provided by the wireless base station 1.

The wireless terminals 2 and 3 are able to perform wireless communication with the wireless base station 1 that provides wireless areas to which the wireless terminals 2 and 3 belong. That is, the wireless terminals 2 and 3 function as receiving apparatuses that receive wireless signals from the wireless base station 1, which serves as the transmitting apparatus.

In the example illustrated in FIG. 2, the wireless base station 1 is able to perform wireless communication directly with the wireless terminals 2 and 3. However, the wireless base station 1 may perform wireless communication indirectly with the wireless terminals 2 and 3 via a wireless relay.

In the above-described wireless communication system 10, the wireless base station 1 transmits a downlink signal to the wireless terminals 2 and 3, while the wireless terminals 2 and 3 transmit an uplink signal to the wireless base station 1. It is noted that the communication direction from the wireless base station 1 to the wireless terminals 2 and 3 is referred to as “downlink”, while the direction from the wireless terminals 2 and 3 to the wireless base station 1 is referred to as “uplink”.

In this embodiment, for example, the wireless base station 1 and the wireless terminal 2 each have the same codebook in which usable weight sets are stored, and the wireless base station 1 transmits wireless signals (downlink signals) to a wireless terminal 2 among the plurality of wireless terminals 2 and 3 by using a plurality of antennas.

The wireless terminal 2 receives the wireless signals transmitted from the wireless base station 1 via the plurality of antennas of the wireless base station 1, and estimates a channel matrix for wireless propagation paths between the wireless base station 1 and the wireless terminal 2. Then, based on the estimation result of the channel matrix (hereinafter being referred to as the “channel estimation result”, for example), the wireless terminal 2 selects, from among a plurality of transmission weights, a transmission weight that allows the quality of a wireless signal to satisfy specified and/or predetermined criteria. Examples of the specified and/or predetermined criteria are the reception gain or the reception quality being maximized. Further, the wireless terminal 2 feeds back the index (PMI) corresponding to the selected transmission weight or the channel state information (CSI) to the wireless base station 1. That is, the wireless signal (uplink signal) transmitted from the wireless terminal 2 to the wireless base station 1 includes information concerning the transmission weight selected by the wireless terminal 2.

Then, the wireless base station 1 receives the information concerning the index (PMI) or the CSI from the wireless terminal 2, and corrects for a variation among the wireless circuits or the antennas in the wireless base station 1. More specifically, for example, the wireless base station 1 corrects for the phase difference among the plurality of antennas so that the information concerning the transmission weight received from the wireless terminal 2 satisfies the specified and/or predetermined conditions based on positional information concerning the wireless terminal 2.

The wireless base station 1 forms a transmission beam by using the transmission weight corresponding to the information fed back from the wireless terminal 2, and then continues communicating with the wireless terminal 2 by using the formed transmission beam.

Meanwhile, the wireless base station 1 receives wireless signals from the wireless terminal 3 by using the plurality of antennas for which the phase difference has been corrected. The wireless base station 1 then estimates the directions of arrival of uplink signals (directions θ₁ and θ₂ in FIG. 2) received from the wireless terminals 3-1 and 3-2 or the channel matrix for the wireless propagation paths between the wireless base station 1 and the wireless terminal 3. The wireless base station 1 then forms transmission beams corresponding to the wireless terminals 3-1 and 3-2 based on the channel estimation result, and transmits wireless signals (downlink signals) to the wireless terminals 3-1 and 3-2 by using the formed beams.

That is, in this embodiment, at least for a certain wireless terminal (in this case, the wireless terminal 2 illustrated in FIG. 2), the wireless base station 1 performs beamforming by using the precoding method. That is, the wireless terminal 2 performs channel estimation processing by using the user-common pilot signal transmitted from the wireless base station 1. The wireless terminal 2 then selects the optimal weight set from the codebook (or precoding matrix) based on the channel estimation result, and feeds back information concerning the index corresponding to the selected weight set to the wireless base station 1. Then, the wireless base station 1 corrects for a variation among the wireless circuits or the antennas in the wireless base station 1 based on the information fed back from the wireless terminal 2.

This eliminates the necessity of providing a calibrator in the configuration of the wireless base station 1, thereby reducing the manufacturing cost of the wireless base station 1 and also improving the versatility of the wireless base station 1. That is, in this embodiment, concerning calibration, advantages similar to those of the related art are obtained. However, an approach to implementing calibration is very different from that of the related art. In this embodiment, hardware specially used for implementing calibration is not required in the wireless base station 1.

In contrast, for other wireless terminals (in this case, the wireless terminals 3-1 and 3-2 illustrated in FIG. 2), the wireless base station 1 performs beamforming by using the non-precoding method. For example, after correcting for a variation among the wireless circuits or the antennas, the wireless base station 1 estimates a channel matrix between the wireless base station 1 and the wireless terminal 3. The wireless terminal 3 is able to perform channel estimation by using a user-individual pilot signal.

Then, the wireless base station 1 estimates the direction of arrival of the uplink signal received from the wireless terminal 3 based on the channel estimation result, and then forms a desired transmission beam based on the estimation result. The wireless base station 1 then transmits a downlink signal by using the formed transmission form.

Accordingly, the wireless base station 1 performs beamforming based on the directions of arrival of signals and the channel estimation result, thereby enabling the wireless terminal 3 to enhance the reception gain and thus to significantly improve the signal quality.

A description will be given of an example of each of the wireless base station 1 and the wireless terminals 2 and 3. However, the following configurations of the wireless base station 1 and the wireless terminals 2 and 3 are examples only, and it is not intended to restrict the configurations thereof.

### (1.2) Example Configuration of Wireless Terminal 2

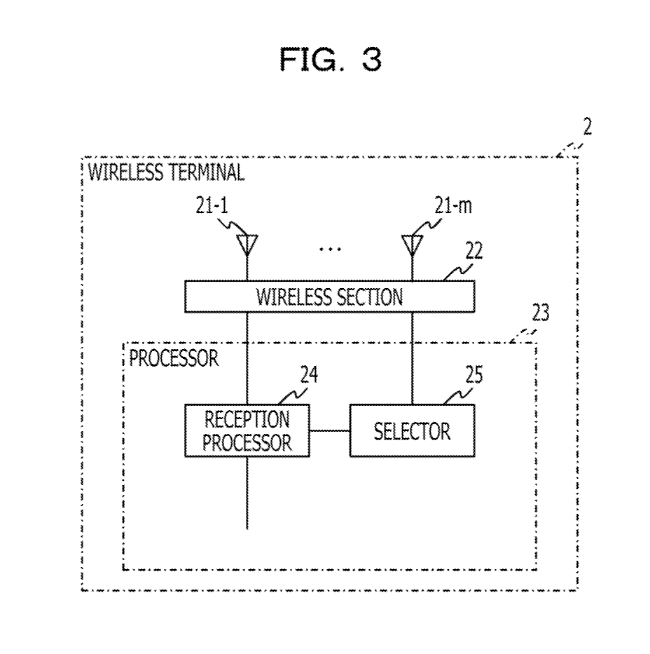

FIG. 3 illustrates an example of the configuration of the wireless terminal 2 according to an embodiment.

The wireless terminal 2 illustrated in FIG. 3 receives wireless signals transmitted from the wireless base station 1 using a plurality of antennas of the wireless base station 1. Accordingly, the wireless terminal 2 includes, as illustrated in FIG. 3 by way of example, antennas 21-1, . . . , and 21-m (m is a natural number), a wireless section 22, and a processor 23. Hereinafter, the antennas 21-1, . . . , and 21-m are collectively referred to as the “antenna 21”) if the antennas are not distinguished from each other.

The antenna 21 receives wireless signals from the wireless base station 1. The wireless signals received by the antenna 21 are sent to the wireless section 22. The antenna 21 may also transmit wireless signals which are subjected to specified and/or predetermined wireless processing performed by the wireless section 22 to the wireless base station 1.

The wireless section 22 performs wireless reception processing, such as down-conversion and analog-to-digital conversion, on the wireless signals received from the wireless base station 1 via the antenna 21. The signals subjected to wireless reception processing by the wireless section 22 are sent to the processor 23.

The wireless section 22 may also perform wireless transmission processing, such as digital-to-analog conversion and up-conversion, on indexes generated by the processor 23. Feedback information concerning an index subjected to wireless transmission processing performed by the wireless section 22 is sent to the antenna 21.

That is, the antenna 21 and the wireless section 22 function as an example of a first receiver that receives wireless signals which are transmitted by utilizing transmission beamforming, and also function as an example of a first transmitter that transmits information, such as an index, concerning a selected transmission weight, as will be described later.

Based on the wireless signals received by the antenna 21 and the wireless section 22, the processor (first processor) 23 selects, from among a plurality of transmission weights, a transmission weight that allows the quality of a wireless signal to satisfy specified and/or predetermined criteria.

Accordingly, the processor 23 includes, as illustrated in FIG. 3 by way of example, a reception processor 24 and a selector 25.

The reception processor 24 extracts a control signal which indicates mapping of the pilot signal (or user-common pilot signal) from the wireless signals received from the wireless base station 1, and extracts the pilot signal from the signals received from the wireless base station 1 based on the extracted control signal. In this case, the reception processor 24 may extract the control signal based on known information concerning the position of the control signal in the received signals. The pilot signal extracted by the reception processor 24 is sent to the selector 25.

The reception processor 24 also extracts, based on the extracted pilot signal, user data from the signals received from the wireless base station 1 and performs specified and/or predetermined reception processing on the extracted user data.

The selector 25 performs channel estimation processing based on the pilot signal extracted by the reception processor 24. Based on the channel estimation result, the selector 25 then selects, from among a plurality of transmission weights, a transmission weight that allows the quality of a wireless signal to satisfy specified and/or predetermined criteria. Accordingly, the selector 25 has the same codebook as that retained in the wireless base station 1.

The selector 25 may select, for example, the following transmission weight, from among a plurality of transmission weights. The transmission weight allows the signal quality, such as the Signal to Interference power Ratio (SIR) or the Signal to Interference and Noise power Ratio (SINR), of a wireless signal to be a specified and/or predetermined threshold or higher.

The selector 25 then sends information concerning the selected transmission weight to the wireless section 22.

The selector 25 may extract, for example, an index corresponding to the selected weight from the codebook and send the extracted index to the wireless base station 1.

### (1.3) Example Configuration of Wireless Terminal 3

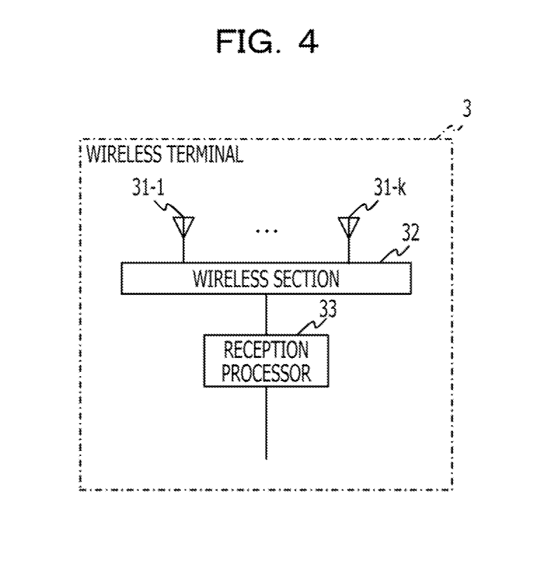

FIG. 4 illustrates an example of the configuration of the wireless terminal 3 according to an embodiment.

The wireless terminal 3 illustrated in FIG. 4 receives wireless signals transmitted from the wireless base station 1. Accordingly, the wireless terminal 3 includes, as illustrated in FIG. 4 by way of example, antennas 31-1, . . . , and 31-k (k is a natural number), a wireless section 32, and a reception processor 33. Hereinafter, the antennas 31-1, . . . , and 31-k are collectively referred to as the “antenna 31”) if the antennas are not distinguished from each other.

The antenna 31 receives wireless signals from the wireless base station 1. The wireless signals received by the antenna 31 are sent to the wireless section 32. The antenna 31 may also transmit wireless signals which are subjected to specified and/or predetermined wireless processing performed by the wireless section 32 to the wireless base station 1.

The wireless section 32 performs wireless reception processing, such as down-conversion and analog-to-digital conversion, on the wireless signals received from the wireless base station 1 via the antenna 31. The signals subjected to wireless reception processing by the wireless section 32 are sent to the reception processor 33.

The antenna 31 and the wireless section 32 function as an example of a third receiver that receives a downlink signal transmitted by the wireless base station 1 after the wireless base station 1 has corrected for the phase difference among the antennas or the wireless circuits, as will be discussed later.

The wireless section 32 may also perform wireless transmission processing, such as digital-to-analog conversion and up-conversion, on an uplink signal to be transmitted to the wireless base station 1. The uplink signal subjected to wireless transmission processing by the wireless section 32 is sent to the antenna 31.

The reception processor 33 extracts a control signal which indicates mapping of the pilot signal (or user-individual pilot signal) from the wireless signals received from the wireless base station 1, and extracts the pilot signal from the wireless signals received from the wireless base station 1 based on the extracted control signal. In this case, the reception processor 33 may extract the control signal based on known information concerning the position of the control signal in the received signals.

The reception processor 33 also extracts, based on the extracted pilot signal, user data from the signals received from the wireless base station 1 and performs specified and/or predetermined reception processing on the extracted user data.

### (1.4) Example Configuration of Wireless Base Station 1

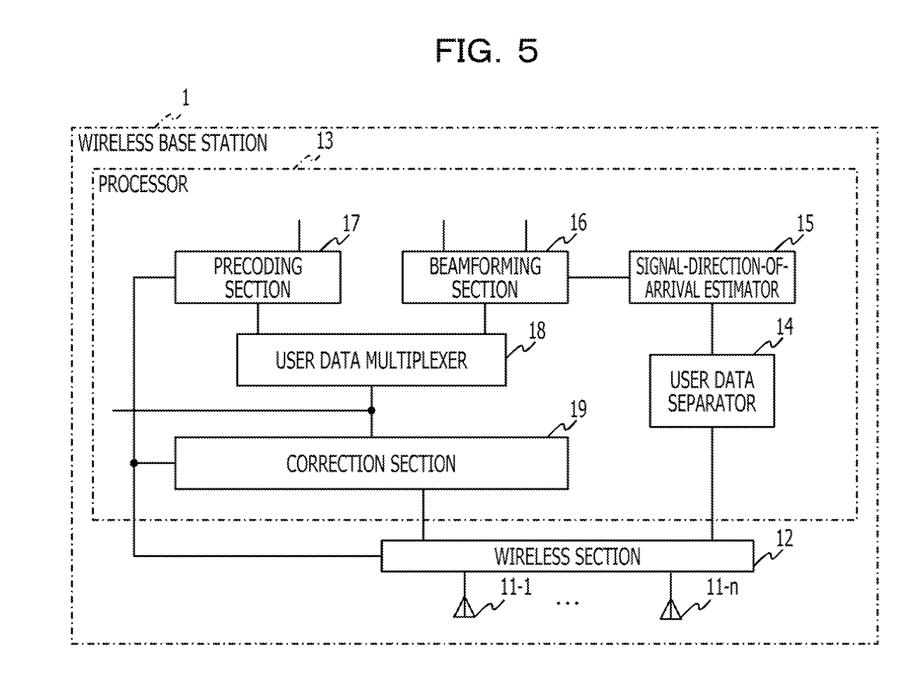

FIG. 5 illustrates an example of the configuration of the wireless base station 1 according to an embodiment.

The wireless base station 1 illustrated in FIG. 5 functions as an example of a transmitting apparatus that transmits wireless signals by utilizing transmission beamforming. Accordingly, the wireless base station 1 includes, as illustrated in FIG. 5 by way of example, a processor 13, a wireless section 12, and antennas 11-1 . . . , and 11-n (n is an integer of two or greater). Hereinafter, the antennas 11-1, . . . , and 11-n are collectively referred to as the “antenna 11”) if the antennas are not distinguished from each other.

The antenna 11 receives wireless signals from the wireless terminals 2 and 3. The wireless signals received by the antenna 11 are sent to the wireless section 12. The antenna 11 may also transmit wireless signals which are subjected to predetermined wireless processing performed by the wireless section 12 to the wireless terminals 2 and 3.

The wireless section 12 performs wireless reception processing, such as down-conversion and analog-to-digital conversion, on the wireless signals received from the wireless terminals 2 and 3 via the antenna 11. The signals subjected to wireless reception processing by the wireless section 12 are sent to the processor 13.

The antenna 11 and the wireless section 12 transmit wireless signals (downlink signals) to the wireless terminal 2 by utilizing transmission beamforming.

The antenna 11 and the wireless section 12 receive from the wireless terminal 2 information concerning a transmission weight selected, from among a plurality of transmission weights, by the wireless terminal 2 based on the quality of wireless signals.

That is, the antenna 11 and the wireless section 12 function as an example of a second receiver that receives information concerning a transmission weight from the wireless terminal 2.

The wireless section 12 may also perform wireless transmission processing, such as digital-to-analog conversion and up-conversion, on downlink signals to be transmitted to the wireless terminals 2 and 3. The uplink signals subjected to wireless transmission processing by the wireless section 12 are sent to the antenna 11.

That is, the antenna 11 and the wireless section 12 function as an example of a second transmitter that transmits wireless signals via the antenna 11 and the wireless section 12 in which the phase difference has been corrected for by the processor 13. The antenna 11 and the wireless section 12 may also transmit wireless signals to the wireless terminal 3 by using a transmission beam corresponding to the wireless terminal 3, as will be discussed later.

The processor (second processor) 13 has a function to correct for the phase difference among the antennas 11 or a plurality of wireless circuits provided in the wireless section 12 so that information concerning a transmission weight received from the wireless terminal 2 satisfies specified and/or predetermined conditions based on the positional information concerning the position of the wireless terminal 2.

The processor 13 estimates the directions of arrival of wireless signals received from the wireless terminal 3 via the antenna 11 and the wireless section 12 for which the phase difference has been corrected. The processor 13 then forms a transmission beam corresponding to the wireless terminal 3 based on the estimation result. The wireless base station 1 transmits wireless signals to the wireless terminal 3 by using the formed transmission beam.

Accordingly, the processor 13 includes, as illustrated in FIG. 5 by way of example, a user data separator 14, a signal-direction-of-arrival estimator 15, a beamforming section 16, a precoding section 17, a user data multiplexer 18, and a correction section 19.

The user data separator 14 separates user data elements contained in the received wireless signals, and plays back the user data elements. The signals separated and played back by the user data separator 14 are sent to the signal-direction-of-arrival estimator 15.

The signal-direction-of-arrival estimator 15 estimates the directions of arrival of the signals based on the signals sent from the user data separator 14. As the signal-direction-of-arrival estimation method, Multiple Signal Classification (MUSIC), for example, may be used.

The MUSIC method is a method for estimating parameters of an arrival signal by using noise components, which are irrelevant to a wireless signal for which the direction of arrival is to be estimated. In the signal-direction-of-arrival measurements according to the MUSIC method, for example, eigenvalues of an autocorrelation matrix obtained from a reception signal are determined, and the obtained eigenvalues are divided into signal eigenvalues and noise eigenvalues in accordance with the arrival wave number. Then, angle spectra are found from noise eigenvectors corresponding to noise eigenvalues, and the angle spectra are averaged by the angle (i.e., the frequency) so as to determine the MUSIC spectrum, thereby estimating the direction of arrival of a wireless signal. It is noted that the signal direction-of-arrival estimation is not restricted to the MUSIC method and may be performed by another estimation method.

The beamforming section 16 applies weights to signals to be transmitted from the antenna 11 based on the estimation result of the signal-direction-of-arrival estimator 15, and then performs beamforming processing for forming a desired transmission beam.

It is now assumed, for example, the signal-direction-of-arrival estimator 15 has estimated that the wireless terminal 3-1 is positioned in the direction at an angle θ₁ with respect to the wireless base station 1 and that the wireless terminal 3-2 is positioned in the direction at an angle θ₂ with respect to the wireless base station 1. In this case, the beamforming section 16 may form a transmission beam that causes signals to be transmitted to the wireless terminal 3-1 so that the reception gain becomes maximized in the wireless terminal 3-1 and the reception gain becomes minimized in the wireless terminal 3-2.

On the other hand, the beamforming section 16 may form a transmission beam that causes signals to be transmitted to the wireless terminal 3-2 so that the reception gain becomes maximized in the wireless terminal 3-2 and that the reception gain becomes minimized in the wireless terminal 3-1.

Alternatively, the beamforming section 16 may form transmission beams that cause signals to be transmitted to the wireless terminals 3-1 and 3-2 so that the reception gain becomes maximized in the wireless terminals 3-1 and 3-2 and that the reception gain becomes minimized in the directions other than the directions θ₁ and θ₂.

The precoding section 17 has a codebook in which usable weight sets are stored. The codebook has the same content as that of the codebook retained in the wireless terminal 2.

First, in order to transmit wireless signals by using a plurality of transmission weights to the wireless terminal 2, the precoding section 17 forms a plurality of transmission beams obtained by multiplying a plurality of transmission weights. The precoding section 17 also forms a transmission beam corresponding to information concerning a transmission weight selected by the wireless terminal 2.

The user data multiplexer 18 multiplexes a signal which is supplied from the precoding section 17 and is to be transmitted to the wireless terminal 2 with a signal which is supplied from the beamforming section 16 and is to be transmitted to the wireless terminal 3. The user data multiplexer 18 then supplies the multiplexed signal to the wireless section 12 via the correction section 19.

The correction section 19 corrects for a variation, such as the phase difference, among the antennas 11 or the wireless circuits based on information fed back from the wireless terminal 2.

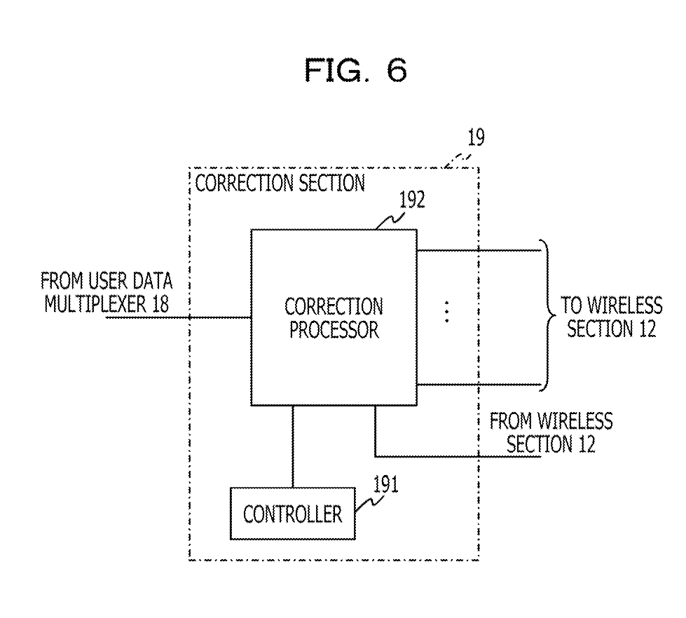

Accordingly, the correction section 19 includes, as illustrated in FIG. 6 by way of example, a controller 191 and a correction processor 192.

The controller 191 provides a target value of the index (hereinafter referred to as the “desired index”) based on the positional information concerning the position of the wireless terminal 2. For example, the controller 191 determines the desired index in the following manner. The wireless base station 1 transmits wireless signals to the wireless terminal 2 in the state in which there is no variation, such as the phase difference, among the antennas 11. In this case, the wireless terminal 2 possesses positional information which is known to the wireless base station 1. Upon receiving the wireless signals from the wireless base station 1, the wireless terminal 2 feeds back the index to the wireless base station 1. The wireless base station 1 determines this index as the desired index.

Thus, the controller 191 may obtain and store in advance an index which is fed back from the wireless terminal 2 after correcting for a variation among the antennas 11 by using, for example, an external calibrator.

The controller 191 may obtain desired indexes in a similar manner in accordance with a plurality of items of positional information concerning the positions of the wireless terminal 2.

As described above, in this embodiment, the wireless base station 1 corrects for a variation among the antennas 11 based on the desired index which is obtained in advance. Accordingly, it is desirable that the positional information concerning the position of the wireless terminal 2 be known to the wireless base station 1. It is also desirable that, in order to prevent a desired index from being changed, the wireless terminal 2 be a fixed station.

The correction processor 192 controls the phase difference among the antennas 11 or the wireless circuits in the direction in which the desired index provided from the controller 191 coincides with the index fed back from the wireless terminal 2, thereby correcting for a variation among the antennas 11 or the wireless circuits.

For example, the correction processor 192 may repeat the above- described correction processing until the index which is repeatedly sent from the wireless terminal 2 regularly or irregularly coincides with the above-described desired index.

The correction section 19 may perform the above-described correction processing regularly or irregularly. During the period in which the correction section 19 does not perform the correction processing, power supply to the correction section 19 may be stopped, or the correction section 19 may be set in the standby mode (sleep mode), thereby achieving low power consumption.

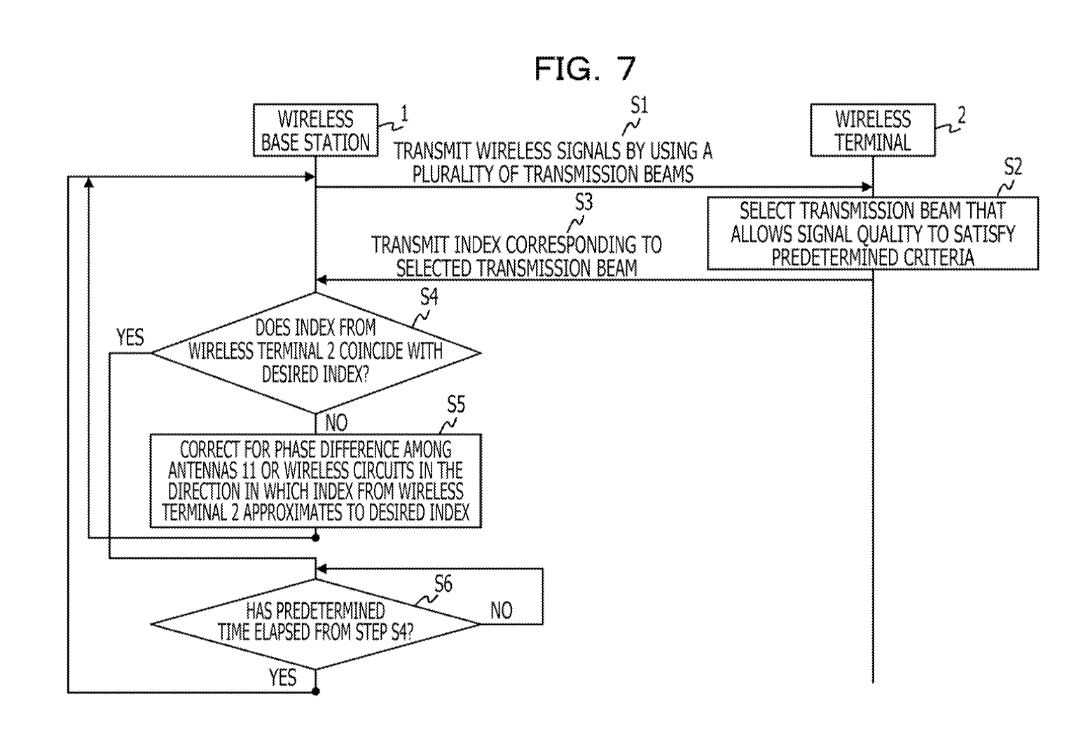

FIG. 7 illustrates an example of a processing sequence of the wireless communication system 10.

In the processing sequence illustrated in FIG. 7, in operation S1, the wireless base station 1 first transmits wireless signals to the wireless terminal 2 by using a plurality of antennas 11.

In operation S2, the wireless terminal 2 receives the wireless signals transmitted from the wireless base station 1 via the plurality of antennas 11, and selects, from among a plurality of transmission weights, a transmission weight that allows the quality of a signal to satisfy specified and/or predetermined criteria. For example, as described above, the SIR or SINR of wireless signals may be used as the quality criteria.

In operation S3, the wireless terminal 2 extracts the index corresponding to the selected transmission weight from the codebook and feeds back the extracted index to the wireless base station 1.

In operation S4, upon receiving the index fed back from the wireless terminal 2, the wireless base station 1 determines whether the received index coincides with the desired index which has been calculated based on the positional information concerning the position of the wireless terminal 2.

There may be cases where the index fed back from the wireless terminal 2 does not coincide with the desired index even if the wireless base station 1 has corrected for a variation among the antennas 11 or the wireless circuits. In this case, it is determined in operation S4 whether the difference between the index fed back from the wireless terminal 2 and the desired index is equal to or less than a specified and/or predetermined threshold. If the difference between the two indexes is equal to or less than the threshold, it may be considered that the index from the wireless terminal 2 coincides with the desired index.

If it is determined in operation S4 that the index received from the wireless terminal 2 does not coincide with the desired index (i.e., the result of operation S4 is NO), the process proceeds to operation S5. In operation S5, the wireless base station 1 corrects for a variation, such as the phase difference, among the antennas 11 or the wireless circuits in the direction so that the two indexes become closer to each other.

The process then returns to operation S1. Then, operations S1 through S5 are repeated until the index received from the wireless terminal 2 coincides with the desired index (or the difference between the two indexes becomes equal to or less than the specified and/or predetermined threshold).

If it is determined in operation S4 that the index received from the wireless terminal 2 coincides with the desired index (i.e., the result of operation S4 is YES), the process proceeds to operation S6. In operation S6, the wireless base station 1 calculates the lapse of time from the previous execution of operation S4 to the current time and determines whether the calculated time exceeds a predetermined time.

If it is determined in operation S6 that the specified and/or predetermined time has not elapsed (i.e., the result of operation S6 is NO), the wireless base station 1 continues executing operation S6. During the period in which the specified and/or predetermined time has not elapsed, power supply to the correction section 19 may be stopped or the correction section 19 may be set in the standby mode (sleep mode), as described above, thereby achieving low power consumption.

If it is determined in operation S6 that the specified and/or predetermined time has elapsed (i.e., the result of operation S6 is YES), the process returns to operation S1. Then, operations S1 through S5 are repeated until the index received from the wireless terminal 2 coincides with the desired index (or the difference between the two indexes becomes equal to or less than the predetermined threshold). If power supply to the correction section 19 has stopped, or if the correction section 19 has been set in the standby mode, power supply to the correction section 19 is started, or the correction section 19 may be returned from the standby mode.

As described above, in this embodiment, calibration processing in the antennas 11 (or wireless circuits) of the wireless base station 1 is performed based on the index fed back from the wireless terminal 2. This makes it possible to eliminate the need to provide a calibrator in order to correct for a variation among the antennas 11 or the wireless circuits, thereby reducing the manufacturing cost of the wireless base station 1.

Additionally, before transmitting wireless signals to the wireless terminal 3, the wireless base station 1 performs beamforming processing based on the signal-direction-of-arrival or the channel estimation result and transmits signals by using the formed beam to the wireless terminal 3. With this operation, the reception gain may be enhanced in the wireless terminal 3, thereby significantly improving the signal quality.

### [2] First Modified Example

In the above-described embodiment, the wireless terminal 2 possesses positional information which is known to the wireless base station 1. Alternatively, a fixed station 2A may substitute for the wireless terminal 2. In this case, the position of the fixed station 2A is specified by a wireless base station 1A, that is, the positional information concerning the position of the fixed terminal 2A is known to the wireless base station 1A.

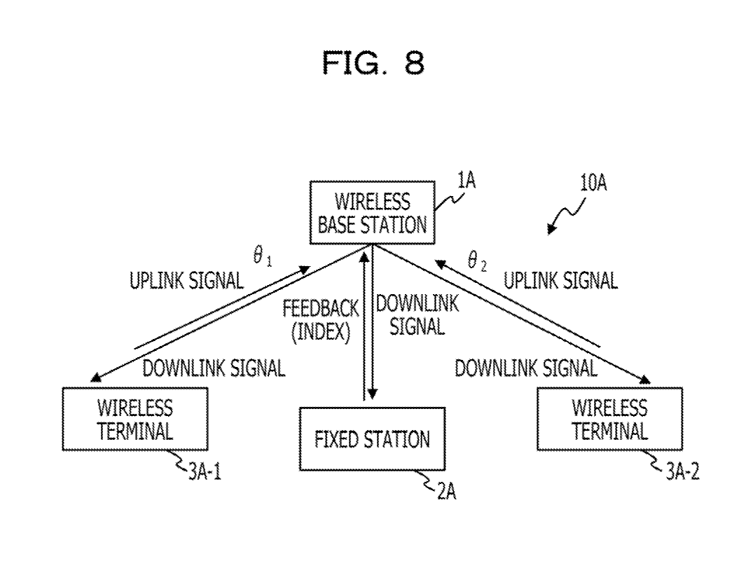

FIG. 8 illustrates an example of the configuration of a wireless communication system 10A according to a first modified example.

The wireless communication system 10A includes, as illustrated in FIG. 8 by way of example, the wireless base station 1A, the fixed station 2A, and wireless terminals 3A-1 and 3A-2. Hereinafter, the wireless terminals 3A-1 and 3A-2 are collectively referred to as the “wireless terminal 3A”) if they are not distinguished from each other.

The wireless base station 1A, the fixed station 2A, and the wireless terminal 3A have functions similar to those of the wireless base station 1, the wireless terminal 2, and the wireless terminal 3, respectively, of the wireless communication system 10.

That is, in this example, the wireless base station 1A transmits wireless signals (downlink signals) to the fixed station 2A by using a plurality of antennas.

The fixed station 2A receives the wireless signals from the wireless base station 1A and selects, from among a plurality of transmission weights, a transmission weight that allows the quality of a wireless signal to satisfy predetermined criteria. The fixed station 2A then feeds back information concerning the index corresponding to the selected transmission weight to the wireless base station 1A.

Then, the wireless base station 1A corrects for a variation among the antennas or the wireless circuits so that the index received from the fixed station 2A coincides with the desired index which has been obtained based on the positional information concerning the position of the fixed station 2A. The wireless base station 1A then continues wireless communication with the fixed station 2A and the wireless terminal 3A.

Meanwhile, by using wireless signals received from the wireless terminal 3A, the wireless base station 1A estimates the directions (θ₁ and θ₂) of arrival of the received wireless signals or the channel matrix for the wireless propagation paths between the wireless base station 1A and the wireless terminal 3A, and then forms transmission beams based on the direction or channel estimation result.

The wireless base station 1A then transmits wireless signals (downlink signals) to the wireless terminal 3A by using the formed transmission beams.

In this example, advantages similar to those of the above-described embodiment are obtained. Additionally, since the positional information of the fixed station 2A does not change, the desired index is fixed, thereby making it possible to precisely and reliably correct for a variation in the wireless base station 1A.

### [3] Second Modified Example

Alternatively, a mobile station 2B including a Global Positioning System (GPS) 4 may substitute for the wireless terminal 2.

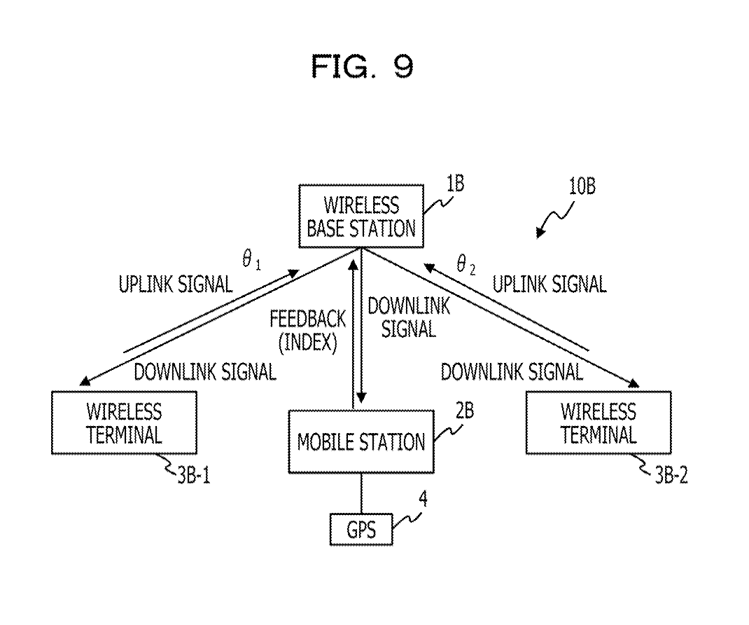

FIG. 9 illustrates an example of the configuration of a wireless communication system 10B according to a second modified example.

The wireless communication system 10B includes, as illustrated in FIG. 9 by way of example, a wireless base station 1B, the mobile station 2B, and wireless terminals 3B-1 and 3B-2. Hereinafter, the wireless terminals 3B-1 and 3B-2 are collectively referred to as the “wireless terminal 3B”) if the terminals are not distinguished from each other.

The wireless base station 1B and the wireless terminal 3B have functions similar to those of the wireless base station 1 and the wireless terminal 3, respectively, of the wireless communication system 10. The mobile station 2B has a function similar to that of the wireless terminal 2 and also has the function of providing positional information concerning the position of the wireless terminal 2B obtained by the GPS 4 to the wireless base station 1B.

That is, in this example, the wireless base station 1B transmits wireless signals (downlink signals) to the mobile station 2B by using a plurality of antennas.

The mobile station 2B receives the wireless signals from the wireless base station 1B and selects, from among a plurality of transmission weights, a transmission weight that allows the quality of a wireless signal to satisfy specified and/or predetermined criteria. The mobile station 2B then feeds back information concerning the index corresponding to the selected transmission weight to the wireless base station 1B.

Then, the wireless base station 1B corrects for a variation among the antennas or the wireless circuits so that the index received from the mobile station 2B coincides with the desired index which has been obtained based on the positional information concerning the position of the mobile station 2B. The wireless base station 1B then continues wireless communication with the mobile station 2B and the wireless terminal 3B.

In this example, after correcting for a variation among the antennas 11 by using, for example, an external calibrator, the wireless base station 1B obtains and stores therein in advance a plurality of sets, each set including an index fed back from the mobile station 2B and positional information concerning the position of the mobile station 2B.

With this arrangement, even if the positional information concerning the position of the mobile station 2B is changed, the wireless base station 1B obtains the changed positional information from the mobile station 2B, and then obtains the desired index corresponding to the current position of the mobile station 2B.

Meanwhile, by using wireless signals received from the wireless terminal 3B, the wireless base station 1B estimates the directions (θ₁ and θ₂) of arrival of the received wireless signals or the channel matrix for the wireless propagation paths between the wireless base station 1B and the wireless terminal 3B, and then forms transmission beams based on the direction or channel estimation result.

The wireless base station 1B then transmits wireless signals (downlink signals) to the wireless terminal 3B by using the formed transmission beams.

As described above, in this example, advantages similar to those of the above-described embodiment are obtained. Additionally, even if the positional information of the mobile station 2B is changed, the value of the desired index may be flexibly changed, thereby making it possible to precisely and reliably correct for a variation in the wireless base station 1B.

There may be a case where the mobile station 2B including the GPS 4 is not present in the wireless area provided by the wireless base station 1B, or has disappeared from the wireless area. The wireless base station 1B may identify such a situation since there is no feedback from the mobile station 2B.

To deal with such a situation, the wireless base station 1B may store control information used for correction processing performed immediately before the mobile station 2B disappeared from the wireless area, and may correct for a variation in the wireless base station 1B based on the stored control information.

Alternatively, the wireless base station 1B may perform control so that all the wireless terminals 3B positioned in the wireless area provided by the wireless base station 1B are operated in accordance with the precoding method. If such control is performed, the wireless terminals 3B may be configured to switch between the precoding method and the non-precoding method in accordance with a control message from the wireless base station 1B.

There may also be a case where a plurality of mobile stations 2B including the GPS 4 are present in the wireless area provided by the wireless base station 1B. The wireless base station 1B may identify such a situation since a plurality of indexes are fed back from the mobile stations 2B.

In this case, the wireless base station 1B may select, from the plurality of mobile stations 2B, the mobile station 2B that feeds back the index which appears to be the most reliable, for example, the mobile station 2B which is positioned the closest to the wireless base station 1B (the distance from the wireless base station 1 to that mobile station 2B is the smallest), and performs the above-described correction processing by using the index received from the selected mobile station 2B.

When the mobile station 2B reports GPS information (or positional information) to the wireless base station 1B, information concerning, for example, an index, from the mobile station 2B reaches the wireless base station 1B via various propagation paths (or channels) depending on the positions of the wireless base station 1B and the mobile station 2B or the surrounding geographic features.

In terms of calibration, more precise correction processing may be implemented by the use of an index from a mobile station 2B having a better view environment than by the use of an index that reaches the wireless base station 1B via a complicated propagation path. It is thus desirable that the wireless base station 1B preferentially use the index sent from the mobile station 2B having a better view environment.

Alternatively, the wireless base station 1B receives indexes from the plurality of mobile stations 2B in a time division manner, and corrects for a variation among the antennas 11 or the wireless circuits of the wireless base station 1B by using the indexes in a time division manner.

Alternatively, the wireless base station 1B weights the indexes received from the mobile stations 2B in a time division manner in accordance with the distances from the wireless base station 1B to the mobile stations 2B, and then corrects for a variation among the antenna 11 or the wireless circuits by using the weighted indexes. In this case, as the distance from the wireless base station 1B to the mobile station 2B is smaller, a larger weight may be applied to that mobile station 2B. Conversely, as the distance from the wireless base station 1B to the mobile station 2B is larger, a smaller weight may be applied to that mobile station 2B.

### [4] Third Modified Example

Further, as in a third modified example, a different wireless base station 5 may substitute for the wireless terminal 2. The position of the wireless base station 5 is specified by a wireless base station 1C, that is, the different wireless base station 5 possesses positional information which is known to the wireless base station 1C.

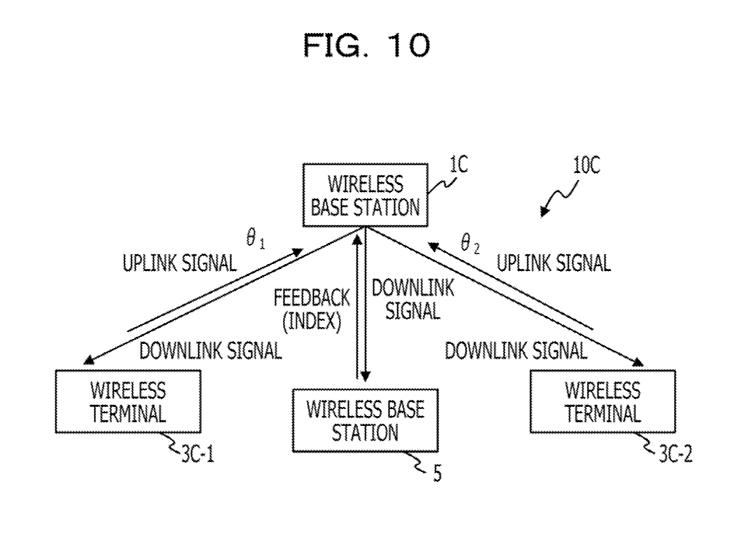

FIG. 10 illustrates an example of the configuration of a wireless communication system 10C according to the third modified example.

The wireless communication system 10C includes, as illustrated in FIG. 10 by way of example, the wireless base station 1C, the different wireless base station 5, and wireless terminals 3C-1 and 3C-2. Hereinafter, the wireless terminals 3C-1 and 3C-2 are collectively referred to as the “wireless terminal 3C”) if the wireless terminals are not distinguished from each other.

The wireless base station 1C and the wireless terminal 3C have functions similar to those of the wireless base station 1 and the wireless terminal 3, respectively, of the wireless communication system 10. The different wireless base station 5 may have a function similar to that of the wireless terminal 2 and may also have a function similar to that of the wireless base station 1.

That is, in this example, the wireless base station 1C transmits wireless signals to the different wireless base station 5 by using a plurality of antennas.

The different wireless base station 5 receives wireless signals from the wireless base station 1C and selects, from among a plurality of transmission weights, a transmission weight that allows the quality of a wireless signal to satisfy specified and/or predetermined criteria. The different wireless base station 5 then feeds back information concerning, for example, the index corresponding to the selected transmission weight, to the wireless base station 1C.

Then, the wireless base station 1C corrects for a variation among the antennas or the wireless circuits so that the index received from the different wireless base station 5 coincides with the desired index which has been obtained based on the positional information concerning the position of the different wireless base station 5. The wireless base station 1C then continues wireless communication with the different wireless base station 5 and the wireless terminal 3C.

Meanwhile, by using wireless signals received from the wireless terminal 3C, the wireless base station 1C estimates the directions (θ₁ and θ₂) of arrival of the received wireless signals or the channel matrix for the wireless propagation paths between the wireless base station 1C and the wireless terminal 3C, and then forms transmission beams based on the direction or channel estimation result.

The wireless base station 1C then transmits wireless signals (downlink signals) to the wireless terminal 3C by using the formed transmission beams.

In this example, advantages similar to those of the above-described embodiment are obtained. Additionally, since the positional information of the different wireless base station 5 does not change, it is possible to precisely and reliably correct for a variation among the antennas 11 or the wireless circuits in the wireless base station 1C.

### [5] Others

The configurations and functions of the wireless base stations 1, 1A, 1B, and 1C, the wireless terminal 2, the fixed station 2A, the mobile station 2B, and the different wireless base station 5 according to the above-described embodiment and modified examples may be selected as necessary and may be combined appropriately. That is, in order to fulfill the functions of the present invention, the above-described configuration and functions may be selected or combined appropriately.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present invention(s) has(have) been described in detail, it should be understood that the various changes, substitutions, and alterations could be made hereto without departing from the spirit and scope of the invention.

What is claimed is:

1. A wireless communication system comprising:
a transmitting apparatus that includes a plurality of antennas and that transmits wireless signals by utilizing transmission beamforming; and
a plurality of receiving apparatuses that receive the wireless signals from the transmitting apparatus,
a first receiving apparatus among the plurality of receiving apparatuses including
a first receiver that receives wireless signals transmitted from the plurality of antennas of the transmitting apparatus,
a first processor that selects, from among a plurality of transmission weights, a transmission weight that allows a quality of a wireless signal to satisfy specified criteria, and
a first transmitter that transmits weight information concerning the selected transmission weight to the transmitting apparatus,
the transmitting apparatus including
a second receiver that receives the weight information from the first receiving apparatus, and
a second processor that corrects for a phase difference among the plurality of antennas based on the weight information, the weight information relating to positional information concerning a position of the first receiving apparatus.

2. The wireless communication system according to claim 1, wherein:
the transmitting apparatus includes a second transmitter that transmits the wireless signals by using the plurality of antennas for which the phase difference has been corrected; and
a second receiving apparatus among the plurality of receiving apparatuses includes a third receiver that receives the wireless signals transmitted from the second transmitter.

3. The wireless communication system according to claim 2, wherein:
the second receiver receives a wireless signal from the second receiving apparatus by using the plurality of antennas for which the phase difference has been corrected;
the second processor estimates a direction of arrival of the wireless signal received from the second receiving apparatus, and forms a transmission beam corresponding to the second receiving apparatus based on the estimated direction of arrival; and
the second transmitter transmits the wireless signals to the second receiving apparatus by using the formed transmission beam.

4. The wireless communication system according to claim 1, wherein the second processor repeatedly corrects for the phase difference among the plurality of antennas until the weight information concerning the selected transmission weight received from the first receiving apparatus satisfies the specified criteria.

5. The wireless communication system according to claim 1, wherein the first receiving apparatus is a fixed station and the positional information which is known to the transmitting apparatus.

6. The wireless communication system according to claim 5, wherein the fixed station is a wireless base station.

7. The wireless communication system according to claim 1, wherein the first transmitter transmits the positional information concerning the position of the first receiving apparatus to the transmitting apparatus.

8. A wireless communication system comprising:
a transmitting apparatus that includes a plurality of antennas and that transmits wireless signals by utilizing transmission beamforming; and
a plurality of receiving apparatuses that receive the wireless signals from the transmitting apparatus,
each of two or more receiving apparatuses among the plurality of receiving apparatuses including
a first receiver that receives wireless signals transmitted from the plurality of antennas of the transmitting apparatus,
a first processor that selects, from among a plurality of transmission weights, a transmission weight that allows a quality of a wireless signal to satisfy specified criteria, and
a first transmitter that transmits, to the transmitting apparatus, weight information concerning the selected transmission weight and positional information concerning the position of the receiving apparatus to which the first transmitter belongs,
the transmitting apparatus including
a second receiver that receives the weight information concerning the selected transmission weight and the positional information from each of the two or more receiving apparatuses, and
a second processor that corrects for a phase difference among the plurality of antennas so that the information concerning the selected transmission weight received from a receiving apparatus, a distance from the receiving apparatus to the transmitting apparatus being the smallest among the two or more receiving apparatuses, satisfies specified conditions based on the positional information concerning the position of the receiving apparatus.

9. A transmitting apparatus that includes a plurality of antennas and that transmits wireless signals by utilizing transmission beamforming, comprising:
a receiver that receives, from a first receiving apparatus among a plurality of receiving apparatuses, first information concerning a transmission weight that allows a quality of a wireless signal to satisfy specified criteria, the transmission weight being selected from a plurality of transmission weights; and
a processor that corrects for a phase difference among the plurality of antennas based on the first information, the first information relating to positional information of the first receiving apparatus.

10. A transmitting apparatus that includes a plurality of antennas and that transmits wireless signals by utilizing transmission beamforming, comprising:
a receiver that receives, from each of two or more receiving apparatuses, weight information concerning a transmission weight that allows a quality of a wireless signal to satisfy specified criteria, the transmission weight being selected from a plurality of transmission weights, and that also receives positional information concerning a position of a corresponding receiving apparatus of the two or more receiving apparatuses; and
a processor that corrects for a phase difference among the plurality of antennas based on the weight information and the positional information of at least one of the two or more receiving apparatuses.

11. A control method for a transmitting apparatus that includes a plurality of antennas and that transmits wireless signals by utilizing transmission beamforming, the control method comprising:
receiving, from a first receiving apparatus among a plurality of receiving apparatuses, first information concerning a transmission weight that allows a quality of a wireless signal to satisfy specified criteria, the transmission weight being selected from a plurality of transmission weights; and
correcting for a phase difference among the plurality of antennas based on the first information, the first information relating to positional information concerning a position of the first receiving apparatus.

12. A control method for a transmitting apparatus that includes a plurality of antennas and that transmits wireless signals by utilizing transmission beamforming, the control method comprising:
receiving, from each of two or more receiving apparatuses, weight information concerning a transmission weight that allows a quality of a wireless signal to satisfy specified criteria, the transmission weight being selected from a plurality of transmission weights, and also receiving positional information concerning a position of a corresponding receiving apparatus of the two or more receiving apparatuses; and
correcting for a phase difference among the plurality of antennas based on the weight information and the positional information of at least one of the two or more receiving apparatuses.
